(19) United States
(12) Patent Application Publication
(10) Pub. No.: US 2020/0084467 A1
(43) Pub. Date: Mar. 12, 2020

(54) LOW LIGHT COMPRESSION

(71) Applicant: Apple Inc., Cupertino, CA (US)

(72) Inventors: Felix CHOU, Saratoga, CA (US); Xiang FU, Mountain View, CA (US); Linfeng GUO, Cupertino, CA (US); Francesco IACOPINO, San Jose, CA (US); Qunxing YANG, Cupertino, CA (US); Xiaohua YANG, San Jose, CA (US); Xu Gang ZHAO, Cupertino, CA (US)

(21) Appl. No.: 16/125,013

(22) Filed: Sep. 7, 2018

(51) Int. Cl. H04N 19/52; H04N 19/172; H04N 19/117; H04N 19/115; H04N 19/124; H04N 19/159

(52) U.S. Cl. CPC H04N 19/52; H04N 19/172; H04N 19/159; H04N 19/115; H04N 19/124; H04N 19/117

(57) ABSTRACT

Systems and methods are disclosed for improving the quality of a reconstructed video sequence that was captured under low light conditions by means of bitrate budget management. In response to a low illumination video capture detection, and based on estimation of the video image characteristics, frame bitrate budget and/or frame rate, used in motion compensated predictive coding techniques, are modified from their default values.

### BACKGROUND

The present disclosure refers to video capturing and compression techniques.

Video compression is ubiquitously used by various electronic devices to facilitate exchange of video content. Video codecs, including the video encoding (“coding”) and decoding operations, are constrained by the bandwidth of the channel through which the coded video stream is transmitted. Hence, at the core of video coding techniques is bitrate budget management. Given a certain bitrate budget, as dictated by the channel bandwidth, coding techniques may aim at minimizing coding distortion by controlling the allocation of bits in the representation of various regions within and across frames. For example, more bits should be allocated to video regions for which the additional allocation will result in a higher reduction in distortion. Bits allocation considerations, thus, depend on the spatiotemporal characteristics of the video sequence. For example, in order to preserve image details, image regions with high variance may require more bits for their representation, otherwise those image details will appear blurred in the reconstructed video. Similarly, in order to preserve high motion video content, an appropriate frame rate may be needed, otherwise motion blur artifacts will show in the reconstructed video.

Generally, to achieve video compression, coding techniques exploit the spatial and temporal redundancy in the image content of a video sequence. For example, a video frame's spatial redundancy may be exploited by allocating less bits in the representation of regions of the video frame with lower image details. Likewise, temporal redundancy may be exploited by representing regions of a video frame based on corresponding regions in previous video frames, employing differential coding. In differential coding, regions from previously coded and decoded image data may be used to predict a currently coded video frame. Then, a difference between the currently coded video frame and its predicted version—namely a residual image—may be coded using operations of transform-based coding, quantization, and entropy-based coding.

The need to preserve details in the video frames and to preserve motion coherency may be complicated by a situation where the video had been captured under low light conditions. Capturing video under low light conditions may result in video frames containing high noise, introduced by increasing the gain in attempt to preserve details, where coding distortion may be exacerbated.

### BRIEF DESCRIPTION OF THE DRAWINGS

FIG. 1 illustrates a video coding system according to an aspect of the present disclosure.

FIG. 2 is a functional block diagram illustrating components of a coding terminal according to an aspect of the present disclosure.

FIG. 3 illustrates a method for managing bitrate budget according to an aspect of the present disclosure.

FIG. 4 is a diagram illustrating a video sequence that may be processed by a coding terminal according to aspects of the present disclosure.

FIG. 5 is a functional block diagram of a coding system according to an aspect of the present disclosure.

FIG. 6 is a functional block diagram of a decoding system according to an aspect of the present disclosure.

### DETAILED DESCRIPTION

The present disclosure describes techniques for improving the quality of a reconstructed (i.e., coded and then decoded) video sequence that was captured under low light conditions. When a video is captured under conditions of low illumination, high noise may be introduced into the video frames when increasing the gain in order to preserve more details. In such a case, lossy coding processes tend to introduce distortions such as blocking artifacts and loss of details, especially in the darker regions of the video frames. To mitigate such coding distortions, aspects of systems and methods disclosed herein devise bitrate budget management techniques that are responsive to detections of low light video capture.

In one such technique, an illumination level may be estimated of frame(s) of a video capture. When the illumination level is below a first threshold, a bitrate budget may be selected that is higher than a default bitrate budget. Otherwise, the bitrate budget may be selected according to the default bitrate budget. The frames may be coded by a motion compensated predictive coding technique using coding parameters determined from the selected bitrate budget.

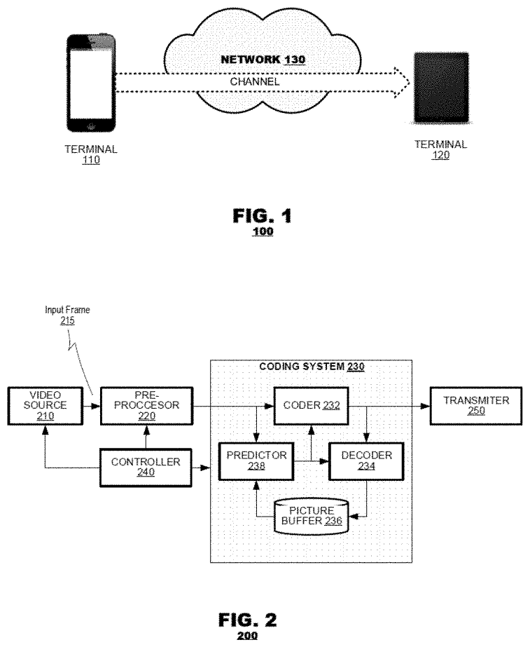

FIG. 1 illustrates a video coding system 100 according to an aspect of the present disclosure. The system 100 may include a pair of terminals, 110 and 120, in communication via a network 130. A source terminal 110 may capture video data (video), and then may code (compress) the video before transmitting the coded video via network 130. Typically, the video is compressed to accommodate network 130 bandwidth limitations. The coded video is then delivered to a target terminal 120 via network 130, where the video is decoded (decompressed) and is made available for consumption. Video consumption may include displaying of the decoded video, storing it, or processing it by an application running on target terminal 120.

During operation, source terminal 110 may capture video frames using an embedded camera system; consume (e.g., display, store, and/or process) the video frames; or code and transmit the video frames to target terminal 120 to be decoded, consumed, and/or further transmitted to another terminal. In an application involving a unidirectional exchange of video, one terminal, e.g., 110, may be a source (coding) terminal and another terminal, e.g., 120, may be a target (decoding) terminal. In an application involving a bidirectional exchange of video, either terminals, 110 or 120, may be a source (coding) terminal or a target (decoding) terminal relative to certain video data to be transmitted or received, respectively. In the coding terminal, the video data may be coded according to a predetermined coding protocol such as the ITU-T's H.265 (“HEVC”), H.264 (“AVC”), or H.263 coding protocols.

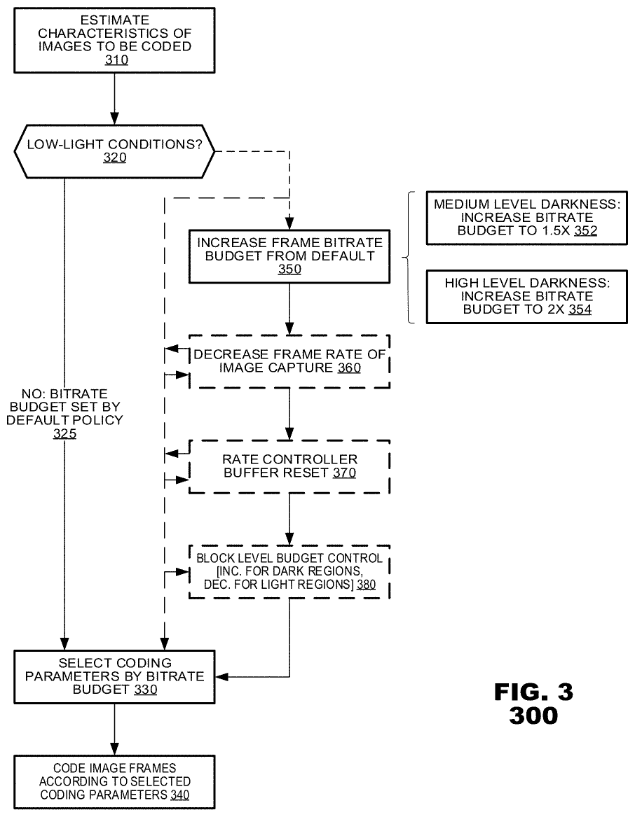

FIG. 2 is a functional block diagram illustrating components of a coding terminal 200 according to an aspect of the present disclosure. The coding terminal 200 may include a video source 210, an image pre-processor 220, a coding system 230, a controller 240, and a transmitter 250. Video source 210 may supply video to be coded. Video source 210 may be a camera system that captures image data of a local environment, a storage device that stores video obtained from some other source, an application that executes on coding terminal 200 and generates video data, or a network connection through which source video data are received. Video source 210 may provide metadata about the video. The metadata may include image features of the video (e.g., brightness level), or may include camera related metadata, such as exposure level, lens aperture, focal length, camera shutter speed, or ISO sensitivity. Image pre-processor 220 may perform signal conditioning operations on the video to be coded to prepare the video for coding. For example, the preprocessor 220 may alter the frame rate, the frame resolution, and/or other properties of the source video. Image pre-processor 220 may also perform filtering operations on the source video, inter alia, to improve the performance of coding system 230. For example, the pre-processer may stabilize the video frames or reduce noise artifacts in the video frames. The preprocessor may estimate video frame characteristics in addition, or as an alternative, to the metadata that may be provided by the video source.

Coding system 230 may perform coding operations on the video to reduce its bandwidth. The coding of a video is generally the operation of re-representing the source video content with a lower bitrate at the price of introducing distortions, ideally not visibly noticeable to the human eye. Coding system 230 may exploit temporal and/or spatial redundancies within the source video to achieve compression while retaining an acceptable video quality level. Coding system 230 may include a coder 232, a decoder 234, a picture buffer 236, and a predictor 238. Coder 232 may apply differential coding techniques to future input frames, coding the difference between input video frames and their corresponding predicted video frames supplied by predictor 238. Decoder 234 may then invert the differential coding techniques applied by coder 232, resulting in decoded (reconstructed) frames that may be designated as reference frames and may be stored in picture buffer 236 for use by predictor 238. Predictor 238 may predict an input video frame using pixel blocks of the reference frames. Transmitter 250 may format the coded video according to a coding protocol, and it may transmit the coded video data to decoding target terminal 120 via network 130.

Coding system 230 may perform motion compensated predictive coding in which video frames or field frames may be partitioned into sub-regions (pixel blocks), and individual pixel blocks may be coded differentially—e.g., each pixel block may be coded with respect to a predicted pixel block. A prediction of the pixel block is made based on previously coded/decoded video data. Pixel blocks may be coded according to different coding modes, each mode bases its prediction (of the predicted pixel block) on different previously-coded/decoded video data. For example: in an intra-prediction mode the previously coded/decoded data may be derived from the same frame; in a single prediction inter-prediction mode the previously coded/decoded data may be derived from a previous frame; and in a multi-hypothesis-prediction mode the previously coded/decoded data may be derived from multiple future and/or previous frames. Instead of coding a video frame, motion compensated predictive coding may allow for the coding of a residual video frame—coding the difference between each pixel block and its corresponding predicted pixel block. The residual frame may then be coded using differential coding techniques—such as transform based coding, quantization, and entropy based coding, as will be explained in detail below.

FIG. 3 illustrates method 300 according to an aspect of the present disclosure. Method 300 may be performed by the coder's controller, 240 or 570, or may be distributed across multiple components of the coding system, 200 or 500. Method 300 may first estimate the image characteristics of the video frames to be coded in box 310. Then, in box 320, those estimated characteristics may be examined to find out whether they are indicative of video captured under low light conditions. If the estimated characteristics do not indicate that the video was captured under low light conditions, then method 300 may decide not to make any changes to the frame bitrate budget that is normally set by the coder's default policy 325. Otherwise, if the estimated characteristics do indicate that the video was captured under low light conditions, the frame bitrate budget may be increased from its default setting in box 350. In doing so, method 300 may distinguish between multiple levels of image darkness. For example, two levels of image darkness may be distinguished: 1) a medium level of darkness, for which, for example, the bitrate budget may be increased by 1.5 from its default level 352; and 2) a high level of darkness, for which, for example, the bitrate budget may be increased by 2 from its default level 354. Then, in box 330, method 300 may select coding parameters according to the bitrate budget, either the default bitrate budget 325 or the increased bitrate budget 350. The selected coding parameters may be used in the coding of video frames in box 340. When it is determined that the video was captured under low light conditions 320, method 300 may include (in addition or alternatively to boxes 350, 352, or 354) boxes of decreasing the frame rate 360, employing rate controller buffer reset 370, and employing block level budget control 380.

Method 300 may begin, in box 310, with the estimation of image characteristics of the video to be coded. The estimated characteristics may be based on the analysis of the video frames' content. The estimated characteristics may be also based on metadata provided by camera sensors, or any other source associated with the capturing or delivering of video source 210. For example, the video frames' content may be processed by the coder's pre-processing unit 220. Thus, the coder, 200 or 500, may detect dark image regions within an input video frame 215. Alternatively, the coder, 200 or 500, may process multiple frames of the video sequence in order to determine statistics indicative of a video capture under low light conditions and to determine the affected image regions of the input video frame 215.

In box 320, a low illumination event—that a video frame 215 received from the video source 210 was captured under low light conditions—may be detected. Detecting a low illumination event may be based on the estimated video frame characteristics obtained in box 310.

In the case where a low illumination event has been detected in box 320, method 300 may decide to increase the bitrate budget in box 350. Thus, when an input frame 215 is detected to have been captured under low light conditions, the coder may increase the bitrate budget available for the coding of that input frame from its default level. The processes in box 350 may adjust the bitrate budget differently for different levels of measured darkness. For example, if the average pixel illumination (brightness) of input frame 215 is below a first threshold, the level of darkness may be determined to be of medium level. While, if the average pixel illumination of input frame 215 is below a second, lower, threshold, the level of darkness may be determined to be of high level. Accordingly, when the level of darkness is determined to be of high level, box 350 may increase the bitrate budget higher than the increase performed for when the level of darkness determined to be of medium level. For example, in box 352, the default bitrate budget may be increased by 2 for a high level of darkness (e.g., SNR 0-20) and, in box 354, the default bitrate budget may be increased by 1.5 for a medium level darkness (e.g., SNR 20-25). For example, when the illumination level is below a first threshold, in step 350, a plurality of thresholds may be determined. These thresholds may correspond to successive values that are lower than the first threshold. Next, when the illumination level is between two successive thresholds, the bitrate budget may be changed from the default value so that it is higher than a bitrate budget selected for an illumination level that is higher than the two successive thresholds and is lower than a bitrate budget selected for an illumination level that is lower than the two successive thresholds.

In the case where a low illumination event had not been detected in box 320, method 300 may decide not to alter the default bitrate budget 325—the default bitrate budget may stay unchanged from its default level. That default bitrate budget may be the one set by the coder, 200 or 500, based on its policies.

In box 330, the coder may determine the coding parameters based on the bitrate budget, either the default bitrate budget 325 or the increased bitrate budget as determined based on boxes 350, 352, or 354, or optionally based on boxes 360, 370, and 380.

Based on the determined coding parameters in box 340, the coder, 200 or 500, may code video frames according to aspects disclosed in reference to FIG. 2 and FIG. 5. The coder may use the determined coding parameters to code input frame 215 and, possibly, to code a subsequently received video frame. The coder may also use the coding parameters determined with respect to input frame 215 in determining the coding parameters determined with respect to a subsequent frame.

When a low illumination event has been detected in box 320, method 300 may decrease the frame rate from its default level in box 360. For example, the frame rate may be reduced from 30 frames per second to 24 frames per second. Alternatively, the reduction in frame rate may also be a function of the video motion level. For example, information regarding the video motion level may be obtained from video source 210 or may be measured by pre-processor 220 within a time window situated relative to the time of input frame 215. Typically, when the video content exhibits high motion characteristics, reducing the frame rate level may only be done to a limited extent. For example, if the frame rate is first reduced with respect to input frame 215, and then the motion level, as obtained or measured with respect to a subsequent input frame, increases, the process in box 360 may increase somewhat the frame rate for frames following that subsequent frame. Note that changes in the frame rate may be carried out by pre-processor 220 by resampling the received video frames, or may be handled by video source 210 in response to a control message from controller 240.

In box 370, the method 300 may reset a controller buffer, such as Hypothetical Reference Decoder (HRD) as used in H.264. A controller buffer, typically, ensures that a coded video stream is correctly buffered and played back at the decoder device given that the bitrate is constrained to a certain maximum. In an aspect, when the method 300 changes the bitrate budgets, the method 300 may reset the buffer's state, which prevents previous analysis overflow or underflow state thereafter from governing coding decisions.

In box 380, processes may be employed locally, at a frame's slice or pixel block level, to mitigate coding distortions resulting from video capture under low light conditions. For example, more bits may be allocated in the representation of slices that overlap dark regions of input frame 215. Typically, under regular coding operations, the coder uses fewer bits to represent dark regions that are flat—regions with low pixel intensity variance—and so having low entropy. To overcome this behavior, box 380 may enforce the allocation of more bits in the representation of those dark regions by, for example, reducing the quantization parameter, Qₚ, used to quantize information associated with those slices. In practice, an increase in coding budget for low light slices will cause a reduction in bit budget for other areas in a frame, such as relatively brighter areas that have low variance. In another aspect, such techniques may be applied at pixel block granularities.

It is expected that operation of method 300 may improve the visual quality of video frames captured under low light conditions by virtue of allocating more bits to represent darker image regions with high noise. Such increased allocation of bits in the representation of darker frames (box 350), as well as increased allocation of bits in the local representation of darker regions within a frame (box 380) may be compensated for by the reduction in frame rate (box 360). Reduction in frame rate may also ensures higher exposure, better capture quality, and less noise in dark frames. Hence, reconstructed video frames that were coded according to aspects of method 300 may better preserve the level of detail and contrast that exists in the original input video frames 210. The reconstructed video frames may demonstrate a reduced amount of artifacts such as blockiness, blurriness, ringing, and color bleeding. Additionally, aspects of method 300 may improve the rate-distortion balance by improving coding quality for such low light frames. In practice, application of the operations 350, 360, and 380 may each be employed independently of each other and in any combination to suit individual application needs.

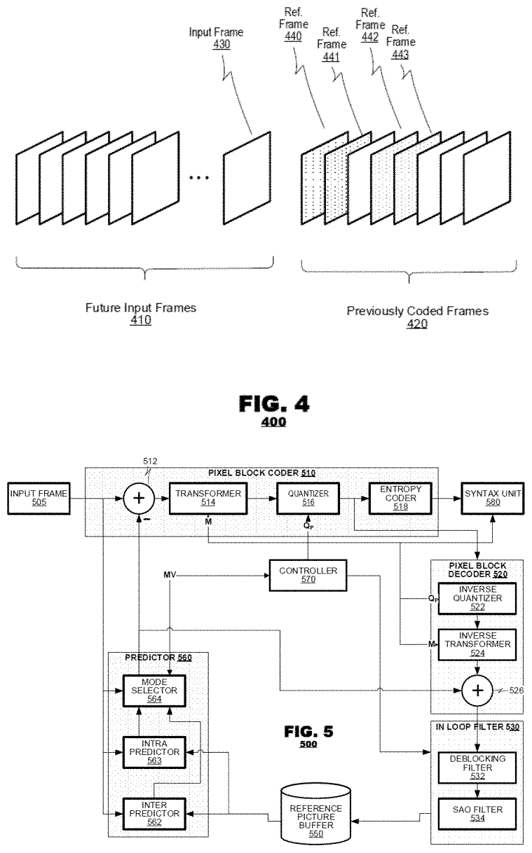

FIG. 4 illustrates an example for a video sequence 400 of video frames processed according to aspects of the present disclosure. Video sequence 400 consists of future input frames 410 and previously coded (processed) frames 420. Aspects disclosed herein may pertain to operations employed spatially, within a video frame, and temporally, across video frames. For example, the coding system 200 may process video sequence 400—coder 200 may pre-process and then may code input frame 430 based on information it may extract from input frame 430, previously coded frames 420, and/or future input frames 410. Furthermore, coder 200 may pre-process and then may code input frame 430 based on metadata it may obtain with respect to input frame 430, previously coded frames 420, and/or future input frames 410. Hence, characteristics of input frame 430 may be estimated based on characteristics of previously coded frames 420 and/or future input frames 410. As discussed above, processed and coded frames 420 may be packed, together with their respective coding parameters, into a coded video stream to be transmitted by transmitter 250 to target terminal 120. Additionally, processed and coded frames that were determined to be used as reference frames, for example frames 440-443, may be stored in picture buffer 236.

Aspects of method 300 (as disclosed herein in reference to boxes 350, 352, 354, 360, 370, and 380) may improve the quality of reconstructed video frames that were captured under low light conditions. Visual quality may be improved as a result of altering the bitrate budget from its default setting in a manner that is responsive to a detection of a low illumination event. A low illumination event, in turn, may be detected based on estimated image characteristics of video frames, where the estimated characteristics indicative of video capture under low light conditions. These estimated characteristics may be based on analyses carried out by pre-processor 220 and/or based on metadata obtained by video source 210. Hence, the estimated characteristics may be derived from, or based on metadata obtained with respect to, input frame 430, future input frames 410, and/or previously coded frames 420.

FIG. 5 is a functional block diagram of a coding system 500 according to an aspect of the present disclosure. System 500 may include a pixel block coder 510, a pixel block decoder 520, an in loop filter 530, a reference picture buffer 550, a predictor 560, a controller 570, and a syntax unit 580. Predictor 560 may predict image data for use during coding of a newly-presented input frame 505; it may supply an estimate for each pixel block of the input frame 505 based on one or more reference pixel blocks retrieved from reference picture buffer 550. Pixel block coder 510 may then code the difference between each input pixel block and its predicted pixel block applying differential coding techniques, and may present the coded pixel blocks (i.e., coded frame) to syntax unit 580. Syntax unit 580 may pack the presented coded frame together with the used coding parameters into a coded video data stream that conforms to a governing coding protocol. The coded frame is also presented to decoder 520. Decoder 520 may decode the coded pixel blocks of the coded frame, generating decoded pixel blocks that together constitute a reconstructed frame. Next, in loop filter 530 may perform one or more filtering operations on the reconstructed frame that may address artifacts introduced by the coding 510 and decoding 520 processes. Reference picture buffer 550 may store the filtered frames obtained from in loop filter 530. These stored reference frames may be used by predictor 560 in the prediction of later-received pixel blocks.

Pixel block coder 510 may include a subtractor 512, a transformer 514, a quantizer 516, and an entropy coder 518. Pixel block coder 510 may receive pixel blocks of input frame 505 at subtractor 512 input. Subtractor 512 may subtract the received pixel blocks from their corresponding predicted pixel blocks provided by predictor 560, or vise versa. This subtraction operation may result in residual pixel blocks, constituting a residual frame. Transformer 514 may transform the residual pixel blocks—mapping each pixel block from its pixel domain into a transform domain, and resulting in transform blocks each of which consists of transform coefficients. Following transformation 516, quantizer 516 may quantize the transform blocks' coefficients. Entropy coder 518 may then further reduce the bandwidth of the quantized transform coefficients using entropy coding, for example by using variable length code words or by using a context adaptive binary arithmetic coder.

Transformer 514 may utilize a variety of transform modes, M, as may be determined by the controller 570. Generally, transform based coding reduces spatial redundancy within a pixel block by compacting the pixels' energy into fewer transform coefficients within the transform block, allowing the spending of more bits on high energy coefficients while spending fewer or no bits at all on low energy coefficients. For example, transformer 514 may apply transformation modes such as a discrete cosine transform (“DCT”), a discrete sine transform (“DST”), a Walsh-Hadamard transform, a Haar transform, or a Daubechies wavelet transform. In an aspect, controller 570 may: select a transform mode M to be applied by transformer 514; configure transformer 514 accordingly; and record, either expressly or impliedly, the coding mode M in the coding parameters.

Quantizer 516 may operate according to one or more quantization parameters, Q_{P}, and may apply uniform or non-uniform quantization techniques, according to a setting that may be determined by the controller 570. In an aspect, the quantization parameter Q_{P} may be a vector. In such a case, the quantization operation may employ a different quantization parameter for each transform block and each coefficient or group of coefficients within each transform block.

Entropy coder 518 may perform entropy coding on quantized data received from quantizer 516. Typically, entropy coding is a lossless process, i.e., the quantized data may be perfectly recovered from the entropy coded data. Entropy coder 518 may implement entropy coding methods such as run length coding, Huffman coding, Golomb coding, or Context Adaptive Binary Arithmetic Coding.

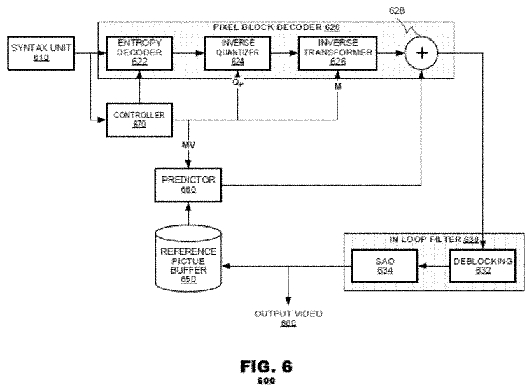

As described above, controller 570 may set coding parameters that are required to configure the pixel block coder 510, including parameters of transformer 514, quantizer 516, and entropy coder 518. Coding parameters may be packed together with the coded residuals into a coded video data stream to be available for a decoder 600 (FIG. 6). These coding parameters may also be made available for decoder 520 in the coder system 500—making them available to inverse quantizer 522 and inverse transformer 524.

A video coder 500 that relies on motion compensated predictive coding techniques may include a decoding functionality 520 in order to generate the reference frames used for predictions by predictor 560. This permits coder 500 to produce the same predicted pixel blocks in 560 as the decoder's in 660. Generally, the pixel block decoder 520 inverts the coding operations of the pixel block coder 510. For example, the pixel block decoder 520 may include an inverse quantizer 522, an inverse transformer 524, and an adder 526. Decoder 520 may take its input data directly from the output of quantizer 516, because entropy coding 518 is a lossless operation. Inverse quantizer 522 may invert operations of quantizer 516, performing a uniform or a non-uniform de-quantization as specified by Q. Similarly, inverse transformer 524 may invert operations of transformer 514 using a transform mode as specified by M. Hence, to invert the coding operation, inverse quantizer 522 and inverse transformer 524 may use the same quantization parameters Q_{P} and transform mode M as their counterparts in the pixel block coder 510. Note that quantization is a lossy operation, as the transform coefficients are truncated by quantizer 516 (according to Q_{P}), and, therefore, these coefficients' original values cannot be recovered by dequantizer 522, resulting in coding error—a price paid to obtain video compression.

Adder 526 may invert operations performed by subtractor 512. Thus, the inverse transformer's output may be a coded/decoded version of the residual frame outputted by subtractor 512, namely a reconstructed residual frame. That reconstructed residual frame may be added 526 to the predicted frame, provided by predictor 560 (typically, the same predicted frame predictor 560 provided to subtractor 512 for the generation of the residual frame at the subtractor output). Hence, adder 526 may result in a coded/decoded version of input frame 505, namely a reconstructed input frame.

Hence, adder 526 may provide the reconstructed input frame to in loop filter 530. In loop filter 530 may perform various filtering operations on the reconstructed input frame, inter alia, to mitigate artifacts generated by independently processing data from different pixel blocks, as may be carried out by transformer 514, quantizer 516, inverse quantizer 522, and inverse transformer 524. Hence, in loop filter 530 may include a deblocking filter 532 and a sample adaptive offset (“SAO”) filter 534. Other filters performing adaptive loop filtering (“ALF”), maximum likelihood (“ML”) based filtering schemes, deringing, debanding, sharpening, resolution scaling, and other such operations may also be employed by in loop filter 530. As discussed above, filtered reconstructed input frames provided by in loop filter 530 may be stored in reference picture buffer 550.

Predictor 560 may base pixel block prediction on previously coded/decoded pixel blocks, accessible from the reference data stored in 550. Prediction may be accomplished according to one of multiple prediction modes that may be determined by mode selector 564. For example, in an intra-prediction mode the predictor may use previously coded/decoded pixel blocks from the same currently coded input frame to generate an estimate for a pixel block from that currently coded input frame. Thus, reference picture buffer 550 may store coded/decoded pixel blocks of an input frame it is currently coding. In contrast, in an inter-prediction mode the predictor may use previously coded/decoded pixel blocks from previously coded/decoded frames to generate an estimate for a pixel block from a currently coded input frame. Reference picture buffer 550 may store these coded/decoded reference frames.

Hence, predictor 560 may include an inter predictor 562, an intra predictor 563, and a mode selector 564. Inter predictor 562 may receive an input pixel block of new input frame 505 to be coded. To that end, the inter predictor may search reference picture buffer 550 for matching pixel blocks to be used in predicting that input pixel block. On the other hand, intra predictor 563 may search reference picture buffer 550, limiting its search to matching reference blocks belonging to the same input frame 505. Both inter predictor 562 and intra predictor 563 may generate prediction metadata that may identify the reference frame(s) (reference frame identifier(s)) and the locations of the used matching reference blocks (motion vector(s)).

Mode selector 564 may determine a prediction mode or select a final prediction mode. For example, based on prediction performances of inter predictor 562 and intra predictor 563, mode selector 564 may select the prediction mode (e.g., inter or intra) that results in a more accurate prediction. The predicted pixel blocks corresponding to the selected prediction mode may then be provided to subtractor 512, based on which subtractor 512 may generate the residual frame. Typically, mode selector 564 selects a mode that achieves the lowest coding distortion given a target bitrate budget. Exceptions may arise when coding modes are selected to satisfy other policies to which the coding system 500 may adhere, such as satisfying a particular channel's behavior, or supporting random access, or data refresh policies. In an aspect, a multi-hypothesis-prediction mode may be employed, in which case operations of inter predictor 562, intra predictor 563, and mode selector 564 may be replicated for each of a plurality of prediction hypotheses.

Controller 570 may control the overall operation of the coding system 500. Controller 570 may select operational parameters for pixel block coder 510 and predictor 560 based on analyses of input pixel blocks and/or based on external constraints, such as coding bitrate targets and other operational parameters. For example, mode selector 564 may output the prediction modes and the corresponding prediction metadata, collectively denoted by MV, to controller 570. Controller 570 may then store the MV parameters with the other coding parameters, e.g., M and Qₚ, and may deliver those coding parameters to syntax unit 580 to be packed with the coded residuals.

During operation, controller 570 may revise operational parameters of quantizer 516, transformer 515, and entropy coder 518 at different granularities of a video frame, either on a per pixel block basis or at a larger granularity level (for example, per frame, per slice, per Largest Coding Unit (“LCU”), or per Coding Tree Unit (“CTU”)). In an aspect, the quantization parameters may be revised on a per-pixel basis within a coded frame. Additionally, as discussed, controller 570 may control operations of decoder 520, in loop filter 530, and predictor 560. For example, predictor 560 may receive control data with respect to mode selection, including modes to be tested and search window sizes. In loop filter 550 may receive control data with respect to filter selection and parameters.

FIG. 6 is a functional block diagram of a decoding system 600 according to an aspect of the present disclosure. Decoding system 600 may include a syntax unit 610, a pixel block decoder 620, an in loop filter 630, a reference picture buffer 650, a predictor 660, and a controller 670.

Syntax unit 610 may receive a coded video data stream and may parse this data stream into its constituent parts, including data representing the coding parameters and the coded residuals. Data representing coding parameters may be delivered to controller 670, while data representing the coded residuals (the data output of pixel block coder 510 in FIG. 5) may be delivered to pixel block decoder 620. Predictor 660 may predict pixel blocks from reference frames available in reference picture buffer 650 using the reference pixel blocks specified by the prediction metadata, MV, provided in the coding parameters. Those predicted pixel blocks may be provided to pixel block decoder 620. Pixel block decoder 620 may produce a reconstructed video frame, generally, by inverting the coding operations applied by pixel block coder 510 in FIG. 5. In loop filter 630 may filter the reconstructed video frame. The filtered reconstructed video frame may then be outputted from decoding system 680. If a frame of those filtered reconstructed video frame is designated to serve as a reference frame, then it may be stored in reference picture buffer 650.

Collaboratively with pixel block coder 510 in FIG. 5, and in reverse order, pixel block decoder 620 may include an entropy decoder 622, an inverse quantizer 624, an inverse transformer 626, and an adder 628. Entropy decoder 622 may perform entropy decoding to invert processes performed by entropy coder 518. Inverse quantizer 624 may invert the quantization operation performed by quantizer 516. Likewise, inverse transformer 626 may invert operations of transformer 514. Inverse quantizer 624 may use the quantization parameters Q_{P} provided by the coding parameters parsed from the coded video stream. Similarly, inverse transformer 626 may use the transform modes M provided by the coding parameters parsed from the coded video stream. Typically, the quantization operation is the main contributor to coding distortions—a quantizer truncates the data it quantizes, and so the output of inverse quantizer 624, and, in turn, the reconstructed residual blocks at the output of inverse transformer 626 possess coding errors when compared to the input presented to quantizer 516 and transformer 514, respectively.

Adder 628 may invert the operation performed by subtractor 512 in FIG. 5. Receiving predicted pixel blocks from predictor 660, adder 628 may add these predicted pixel blocks to the corresponding reconstructed residual pixel blocks provided at the inverse transformer output 626. Thus, the adder may output reconstructed pixel blocks (constituting a reconstructed video frame) to in loop filter 630.

In loop filter 630 may perform various filtering operations on the received reconstructed video frame as specified by the coding parameters parsed from the coded video stream. For example, in loop filter 630 may include a deblocking filter 632 and a sample adaptive offset (“SAO”) filter 634. Other filters performing adaptive loop filtering (“ALF”), maximum likelihood (“ML”) based filtering schemes, deringing, debanding, sharpening, resolution scaling. Other like operations may also be employed by in loop filter 630. In this manner, the operation of in loop filter 630 may mimic the operation of its counterpart in loop filter 530 of coder 500. Thus, in loop filter 630 may output a filtered reconstructed video frame—i.e., output video 680. As discussed above, output video 680 may be consumed (e.g., displayed, stored, and/or processed) by the hosting target terminal 120 and/or further transmitted to another terminal.

Reference picture buffer 650 may store reference video frames, such as the filtered reconstructed video frames provided by in loop filter 630. Those reference video frames may be used in later predictions of other pixel blocks. Thus, predictor 660 may access reference pixel blocks from reference picture buffer 650, and may retrieve those reference pixel blocks specified in the prediction metadata. The prediction metadata may be part of the coding parameters parsed from the coded video stream. Predictor 660 may then perform prediction based on those reference pixel blocks and may supply the predicted pixel blocks to decoder 620.

Controller 670 may control overall operations of coding system 600. The controller 670 may set operational parameters for pixel block decoder 620 and predictor 660 based on the coding parameters parsed from the coded video stream. These operational parameters may include quantization parameters, Q_{P}, for inverse quantizer 624, transform modes, M, for inverse transformer 626, and prediction metadata, MV, for predictor 660. The coding parameters may be set at various granularities of a video frame, for example, on a per pixel block basis, a per frame basis, a per slice basis, a per LCU basis, a per CTU basis, or based on other types of regions defined for the input image.

As discussed above, video coding techniques generally aim at reducing the amount of bits per second required to represent a video sequence, while retaining an acceptable level of image quality of the reconstructed video frames. However, video data with certain characteristics are susceptible to more perceptibly noticeable coding artifacts. For example, a video sequence that had been captured under low light conditions may contain frames with dark regions that may be with high noise. Compression of such frames may cause coding artifacts such as blockiness, blurriness, ringing, and color bleeding in those dark regions. Aspects of the present disclosure provide new bitrate allocation techniques that reduce the coding distortions that may otherwise appear in video captured under low light conditions.

The foregoing discussion has described operations of the aspects of the present disclosure in the context of video coders and decoders. Commonly, these components are provided as electronic devices. Video decoders and/or controllers can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs are typically stored in physical storage media such as electronic-based, magnetic-based storage devices, and/or optically-based storage devices, where they are read into a processor and executed. Decoders are commonly packaged in consumer electronic devices, such as smartphones, tablet computers, gaming systems, DVD players, portable media players, and the like. They can also be packaged in consumer software applications such as video games, media players, media editors, and the like. And, of course, these components may be provided as hybrid systems with distributed functionality across dedicated hardware components and programmed general-purpose processors, as desired.

Video coders and decoders may exchange video through channels in a variety of ways. They may communicate with each other via communication and/or computer networks as illustrated in FIG. 1. In still other applications, video coders may output video data to storage devices, such as electrical, magnetic and/or optical storage media, which may be provided to decoders sometime later. In such applications, the decoders may retrieve the coded video data from the storage devices and decode it.

Several embodiments of the invention are specifically illustrated and/or described herein. However, it will be appreciated that modifications and variations of the invention are covered by the above teachings and within the purview of the appended claims without departing from the spirit and intended scope of the invention.

1. A video coding method, comprising:
estimating an illumination level of frames of a video capture;
when the illumination level is below a first threshold, selecting a bitrate budget that is higher than a default bitrate budget;
otherwise, selecting the bitrate budget according to the default bitrate budget; and
coding the frames by a motion compensated predictive coding technique using coding parameters determined from the selected bitrate budget.

2. The method of claim 1, further comprising, when the illumination level of the frames of the video capture is below the first threshold:
decreasing a frame rate of the video capture from a default frame rate; and
wherein the coding codes the frames of the video capture both before and after the decrease in frame rate.

3. The method of claim 2, wherein the estimating of the illumination level is derived from characteristics of previously coded frames.

4. The method of claim 2, wherein the decreasing the frame rate is of future input frames.

5. The method of claim 2, wherein, after the decrease in frame rate, the coding parameters are determined based on the decreased frame rate.

6. The method of claim 1, further comprising, when the illumination level of the frames of the video capture is below the first threshold,
selecting a plurality of thresholds, the plurality of thresholds having successive values that are lower than the first threshold;
when the illumination level is between two successive thresholds of the plurality of thresholds, the selected bitrate budget is higher than a bitrate budget selected for illumination level that is higher than the two successive thresholds and is lower than a bitrate budget selected for illumination level that is lower than the two successive thresholds.

7. The method of claim 1, further comprising, when the illumination level of the frames of the video capture is below the first threshold, the selected bitrate budget of each frame is allocated to regions of each frame that are dark in high proportion than a respective allocation under the default bitrate budget.

8. The method of claim 1, wherein the estimating of the illumination level is derived from characteristics of previously coded frames.

9. The method of claim 1, wherein the selecting the bitrate budget is of future input frames.

10. A video coding method, comprising:
estimating an illumination level of frames of a video capture;
when the illumination level is below a first threshold, decreasing a frame rate of the video capture from a default frame rate; and
coding the frames of the video capture both before and after the decreasing frame rate by a motion compensated predictive coding technique.

11. The method of claim 10, further comprising:
when the illumination level of the frames of the video capture is below the first threshold, selecting a bitrate budget that is higher than a default bitrate budget;
otherwise, selecting the bitrate budget according to the default bitrate budget; and
wherein the coding the frames is based on coding parameters determined from one of the selected bitrate budgets and the decreased frame rates.

12. The method of claim 10, further comprising, when the illumination level of the frames of the video capture is below the first threshold,
selecting a plurality of thresholds, the plurality of thresholds having successive values that are lower than the first threshold;
when the illumination level is between two successive thresholds of the plurality of thresholds, the selected bitrate budget is higher than a bitrate budget selected for illumination level that is higher than the two successive thresholds and is lower than a bitrate budget selected for illumination level that is lower than the two successive thresholds.

13. The method of claim 10, further comprising, when the illumination level of the frames of the video capture is below the first threshold, the selected bitrate budget of each frame is allocated to regions of the each frame that are dark in high proportion than a respective allocation under the default bitrate budget.

14. The method of claim 10, wherein the estimating of the illumination level is derived from characteristics of previously coded frames previously coded.

15. The method of claim 10, wherein the selecting the bitrate budget is of future input frames.

16. A computer system, comprising:
at least one processor;
at least one memory comprising instructions configured to be executed by the at least one processor to perform a method comprising:
estimating an illumination level of frames of a video capture;
when the illumination level is below a first threshold, selecting a bitrate budget that is higher than a default bitrate budget;
otherwise, selecting the bitrate budget according to the default bitrate budget; and
coding the frames by a motion compensated predictive coding technique using coding parameters determined from the selected bitrate budget.

17. The system of claim 16, further comprising, when the illumination level of the frames of the video capture is below the first threshold:
decreasing a frame rate of the video capture from a default frame rate; and
wherein the coding codes the frames of the video capture both before and after the decrease in frame rate.

18. The system of claim 16, further comprising, when the illumination level of the frames of the video capture is below the first threshold,
selecting a plurality of thresholds, the plurality of thresholds having successive values that are lower than the first threshold;
when the illumination level is between two successive thresholds of the plurality of thresholds, the selected bitrate budget is higher than a bitrate budget selected for illumination level that is higher than the two successive thresholds and is lower than a bitrate budget selected for illumination level that is lower than the two successive thresholds.

19. The system of claim 16, further comprising, when the illumination level of the frames of the video capture is below the first threshold, the selected bitrate budget of each frame is allocated to regions of each frame that are dark in high proportion than a respective allocation under the default bitrate budget.

20. A computer system, comprising:
at least one processor;
at least one memory comprising instructions configured to be executed by the at least one processor to perform a method comprising:
estimating an illumination level of frames of a video capture;
when the illumination level is below a first threshold, decreasing a frame rate of the video capture from a default frame rate; and
coding the frames of the video capture both before and after the decreasing frame rate by a motion compensated predictive coding technique.

21. The system of claim 20, further comprising:
when the illumination level of the frames of the video capture is below the first threshold, selecting a bitrate budget that is higher than a default bitrate budget;
otherwise, selecting the bitrate budget according to the default bitrate budget; and
wherein the coding the frames is based on coding parameters determined from one of the selected bitrate budgets and the decreased frame rates.

22. The system of claim 20, further comprising, when the illumination level of the frames of the video capture is below the first threshold,
selecting a plurality of thresholds, the plurality of thresholds having successive values that are lower than the first threshold;
when the illumination level is between two successive thresholds of the plurality of thresholds, the selected bitrate budget is higher than a bitrate budget selected for illumination level that is higher than the two successive thresholds and is lower than a bitrate budget selected for illumination level that is lower than the two successive thresholds.

23. The system of claim 20, further comprising, when the illumination level of the frames of the video capture is below the first threshold, the selected bitrate budget of each frame is allocated to regions of the each frame that are dark in high proportion than a respective allocation under the default bitrate budget.

24. A non-transitory computer-readable medium comprising instructions executable by at least one processor to perform a method, the method comprising:
estimating an illumination level of frames of a video capture;
when the illumination level is below a first threshold, selecting a bitrate budget that is higher than a default bitrate budget;
otherwise, selecting the bitrate budget according to the default bitrate budget; and
coding the frames by a motion compensated predictive coding technique using coding parameters determined from the selected bitrate budget.

25. The medium of claim 24, wherein the method further comprises, when the illumination level of the frames of the video capture is below the first threshold:
decreasing a frame rate of the video capture from a default frame rate; and
wherein the coding codes the frames of the video capture both before and after the decrease in frame rate.

26. A non-transitory computer-readable medium comprising instructions executable by at least one processor to perform a method, the method comprising:
estimating an illumination level of frames of a video capture;
when the illumination level is below a first threshold, decreasing a frame rate of the video capture from a default frame rate; and
coding the frames of the video capture both before and after the decreasing frame rate by a motion compensated predictive coding technique.

27. The medium of claim 26, wherein the method further comprises:
when the illumination level of the frames of the video capture is below the first threshold, selecting a bitrate budget that is higher than a default bitrate budget;
otherwise, selecting the bitrate budget according to the default bitrate budget; and
wherein the coding the frames is based on coding parameters determined from one of the selected bitrate budgets and the decreased frame rates.
